(19) United States
(12) Patent Application Publication
(10) Pub. No.: US 2008/0304437 A1
(43) Pub. Date: Dec. 11, 2008

(54) TCP Start Protocol For High-Latency Networks

(75) Inventors: Venkataramana DUVVURY, London (GB); Mohsin Meghji, London (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Inmarsat Global Ltd., London (GB)

(21) Appl. No.: 11/760,507

(22) Filed: Jun. 8, 2007

(51) Int. Cl. H04B 7/216

(52) U.S. Cl. 370/320

(57) ABSTRACT

In a TCP start protocol for a network including a link for which a minimum guaranteed transmission bandwidth has been negotiated, packets are transmitted at an initial rate that is inversely dependent on the guaranteed bandwidth, until an acknowledgement is received from the receiver. In this way, congestion in the link is avoided and transmission performance is improved.

### FIELD OF THE INVENTION

The present invention relates to the use of a transmission control protocol, such as TCP, over a high latency network, and particularly to a start protocol suitable for use over a high latency network.

### BACKGROUND OF THE INVENTION

File transfers between applications over the Internet are conducted using a Transmission Control Protocol (TCP). Standard implementations of TCP include a slow start protocol, whereby the initial transmission is limited to a single packet. Once the first packet is acknowledged by the receiver, the transmitter can then transmit double the number of packets in the previous transmission. The transmitter therefore starts from a low initial transmission rate, which then exponentially doubles until saturation is achieved, at which point the slow start phase ends and a TCP congestion management protocol is used instead.

The slow-start algorithm protects the network from an onrush of new data. A large initial burst of data may cause buffer overflow at the first congested node and therefore severe transmission problems. This is avoided by the slow-start protocol, which also prevents the TCP transmitter from increasing to a very high transmission rate before obtaining information about the state of the network, such as round-trip time (RTT) or saturation throughput.

Although the slow-start protocol is advantageous in most conventional networks, it may cause problems in some networks. A first problem arises in high-latency networks, such as satellite networks. In geosynchronous satellite networks, one-way delays may be between 250 and 300 ms even on an unloaded network. Hence, the slow start protocol incurs a round trip time (RTT) of about ½ second on each acknowledgement cycle, so that the slow-start phase takes an unacceptably long time.

A second problem arises where the file to be transmitted is so small that transmission is completed before the end of the slow start protocol, so that the average transmission rate of the file is very low.

Modifications to the slow start protocol for satellite networks are discussed in IETF Network Working Group RFC 2760 (February 2000) at www.ietf.org/rfc/rfc2760.txt, section 3.2. One proposal is to increase the number of packets sent in the initial transmission. However, the TCP protocol does not know the size of the file to be transmitted, and therefore cannot determine the initial number of packets according to the file size. A small initial number of packets will make little difference to the performance of the start protocol, while a large initial number may cause buffer overflow at the next node.

The paper ‘Smooth slow-start: refining TCP slow-start for large-bandwidth with long delay networks’, Nishida, 23^{rd} Local Networks Conference (October 1998), pp. 52-60, discloses a ‘smooth slow start’ protocol in which the transmitter sends only one new packet every time an acknowledgement is received, but also counts the number of acknowledgements received during a timed interval, which is a constant 200 ms. At the end of each interval, the number of acknowledgements received during that interval is added to a running total (the ‘congestion window’) and that number of packets is transmitted at the beginning of the next interval. This makes the slow start less bursty, and reduces the exponential increase. However, the protocol may lead to exponential uncontrolled growth of the congestion window.

The paper ‘Improving TCP/IP over Geostationary Satellite Links’, Barakat et. al., GLOBECOM '99, pp. 781-785, (December 1999) also addresses latency problems of the slow start algorithm, by spacing transmitted packets with a timed interval. An appropriate interval is calculated by estimating the average transmission rate in an initial transmission phase. However, the initial transmission phase may not be a good indicator of actual transmission rate. Also, the protocol is insensitive to fluctuation in RTT.

### SUMMARY OF THE INVENTION

According to one aspect of the invention, there is provided a TCP start protocol in which a minimum guaranteed bandwidth has been established for the transmitter, and packets are transmitted at an initial rate that is inversely dependent on the guaranteed bandwidth. Preferably, the start protocol is terminated as soon as an acknowledgement is received from the receiver. Where the packet size is variable, the initial packet transmission rate may be dependent on the packet size.

An advantage of this start protocol is that transmission performance is substantially improved for small files, while initial congestion is mitigated.

Another advantage is that the start protocol is less dependent on the RTT of the network, and is therefore more suitable for high latency networks.

According to another aspect of the invention, there is provided apparatus arranged to perform the TCP start protocol. The apparatus may comprise a transmitter, such as a packet data terminal.

According to another aspect of the invention, there is provided a computer program or computer program product arranged to perform the TCP start protocol.

### BRIEF DESCRIPTION OF THE DRAWINGS

Specific embodiments of the invention will now be described with reference to the accompanying drawings as identified below.

FIG. 1 is a diagram of an IP network including a satellite link.

FIG. 2 is a flowchart of a TCP start protocol according to an embodiment of the invention.

FIG. 3 is a simplified signal diagram of the TCP start protocol according to embodiments of the invention.

### DETAILED DESCRIPTION OF THE EMBODIMENTS

### Network Architecture

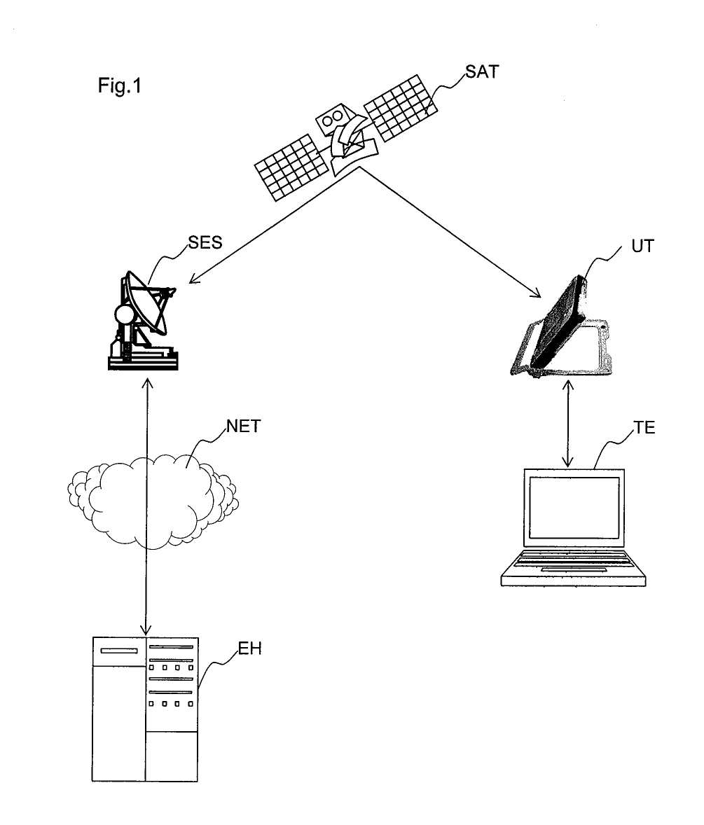

FIG. 1 is a diagram of a network incorporating a satellite link, which is an example of a high-latency network in which embodiments of the invention may be used. In one specific example, the satellite link is provided by the Inmarsat® BGAN® network, which provides TCP/IP-based packet data service via satellite.

Terminal equipment TE, such as a portable computer, is connected to a mobile satellite user terminal UT, for packet data communication via a satellite SAT to a satellite earth station SES. The SES provides a connection via a network NET, such as the Internet, to an end host EH. In this way, a TCP connection may be set up between the terminal equipment TE and the end host EH.

One or more applications may be run between an application client on the terminal equipment TE and an application server on the end host: for example, a web client and a web server, or an email client and an email server.

The BGAN® service is a variable bandwidth service allowing a minimum guaranteed bandwidth to be negotiated by the user terminal UT when setting up a packet data session, for example as described in WO 98/25358. The transmission bandwidth allocated to the user terminal UT may be varied during the session according to current demand, as signalled by the user terminal UT, without falling below the minimum guaranteed bandwidth in normal circumstances. Additional details regarding a BGAN terminal can be found in the Hughes Network Systems BGAN Satellite Terminal User Guide, which is incorporated herein by reference in its entirety.

The BGAN® service and TCP protocols are known in general and further details will not be described herein.

### Start Protocol

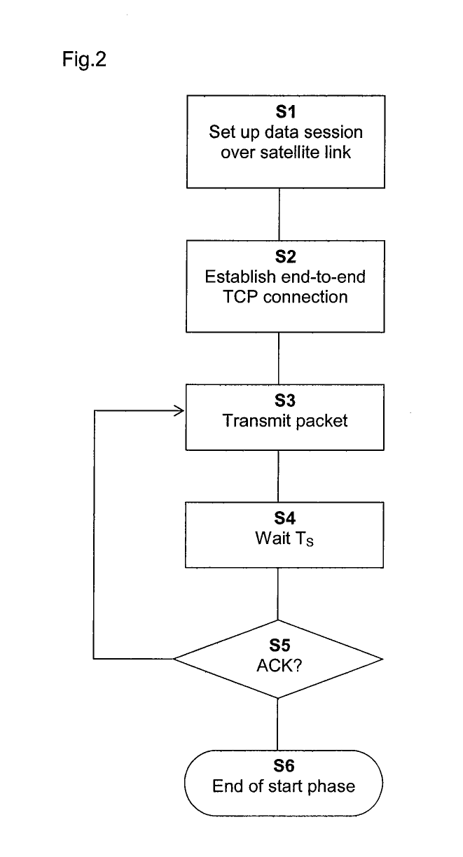

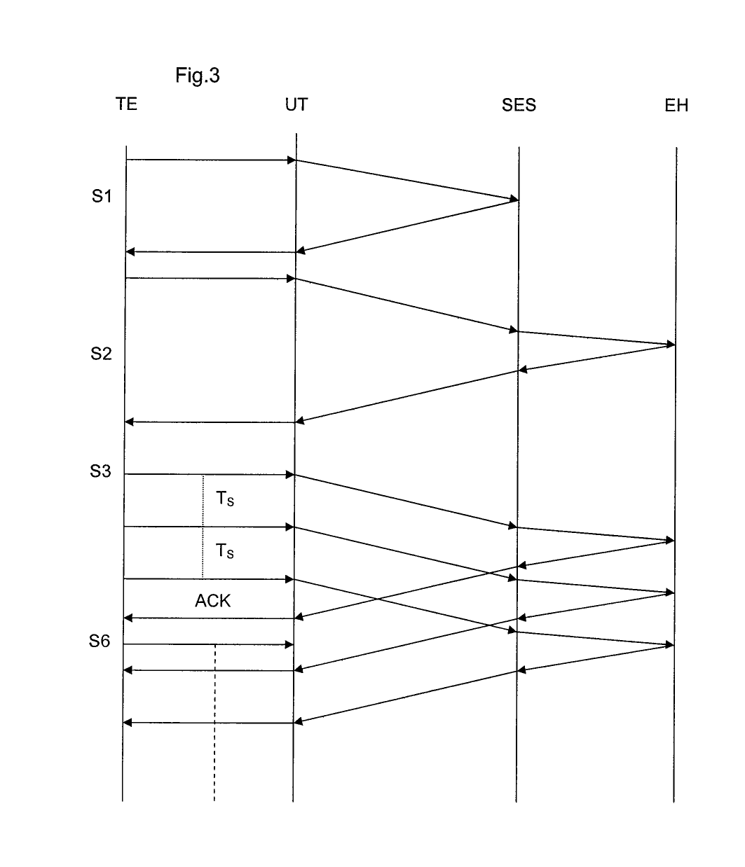

A start protocol in an embodiment of the invention is illustrated by the flowchart of FIG. 2 and the simplified signal diagram of FIG. 3. At step S1, a packet data session is initiated over the satellite link, between the user terminal UT and the satellite earth station SES. The packet data session may be initiated by the terminal equipment TE or the host equipment initiating a TCP connection.

During initiation of the packet data session, a minimum quality of service (QoS) is negotiated, including a guaranteed minimum bandwidth. The minimum bandwidth may vary according to the application for which the TCP connection is being established. For example, a web application may require a higher minimum bandwidth than an email application.

The terminal equipment TE communicates with the user terminal UT during initiation of the packet data session so that the user terminal UT knows for what type of application the packet data session is being initiated, and the terminal equipment TE knows the guaranteed minimum bandwidth that has been negotiated.

Once the packet data session is established over the satellite link, an end-to-end TCP connection is set up between the terminal equipment TE and the end host EH (step 2) and the start protocol then begins.

The terminal equipment TE transmits the first packet in the transmission sequence (step S3), then waits for an interval T_{S} (step S4), where

$${T}_{S} = \frac{PS}{MB}$$

PS=packet size
MB=minimum guaranteed bandwidth

If the terminal equipment TE detects an acknowledgement from the end host EH (step S5), then the start phase ends and a standard TCP congestion management protocol or another TCP protocol is used subsequently (step S6). Otherwise, the terminal equipment transmits the next packet in the sequence (S3) and waits for the interval T_{S} (S4); this process repeats until an acknowledgement is received (S5) and the start phase ends (S6).

Hence, instead of sending a burst of multiple packets and then waiting for a response, the terminal equipment TE sends single packets at intervals T_{S}, such that the transmission bandwidth corresponds substantially to the guaranteed minimum bandwidth. Hence, congestion at the satellite link is avoided. Since the satellite link is likely to have the lowest bandwidth of any link in the end-to-end connection, no other node in the end-to-end TCP connection is likely to become congested. Moreover, bandwidth performance for the transfer of small files is substantially improved.

In an alternative embodiment, each transmission burst may comprise more than one packet, in which case

PS=burst size

In an alternative embodiment, the minimum guaranteed bandwidth may be renegotiated during the packet data session. If this occurs during the start phase, then the interval T_{S} is modified accordingly. The packet size is preferably constant during the start phase but may be varied, in which case the interval T_{S} is modified accordingly.

In an alternative embodiment, data bursts may sent at intervals T_{S} even after the first acknowledgement is received, but the burst size may be varied according to the current bandwidth allocated to the transmission. The current bandwidth may be allocated according to variable demand requests from the user terminal UT, and the current allocated bandwidth may be communicated from the user terminal UT to the terminal equipment TE so that the data burst size can be varied.

The start protocol may be implemented by software, hardware or firmware on the terminal equipment TE and/or the user terminal UT. Preferably, the start protocol may be implemented by software (i.e. a computer program) installed on the terminal equipment TE. The software may be loaded onto the terminal equipment TE by downloading over a network or by loading from removable media.

### Alternative Embodiments

Although the above embodiment is described with reference to a geosynchronous satellite network, the present invention may also be applied to other satellite networks, such as medium earth orbit (MEO) or low earth orbit (LEO) networks, as well as to other types of wireless and/or high-latency network.

The above embodiments are provided purely by way of example and are not limiting on the scope of the present invention. Other alternatives which may be apparent on reading the above description may also fall within the scope of the invention.

What is claimed is:

1. A method of performing a data transmission start protocol over a link, comprising:
a. determining a minimum guaranteed bandwidth for transmission over the link; and
b. transmitting a plurality of data bursts over the link with an interval between bursts determined such that the transmission bandwidth does not significantly exceed the minimum guaranteed bandwidth; wherein the plurality of bursts are transmitted before receiving an acknowledgement of any of said plurality of bursts.

2. The method of claim 1, wherein the interval is inversely proportional to the minimum guaranteed bandwidth.

3. The method of claim 1, wherein each of said data bursts is of substantially equal size, the interval being proportional to said data burst size.

4. The method of claim 1, wherein each of said data bursts comprises a single data packet.

5. The method of claim 1 including, subsequent to reception of said acknowledgement, transmitting subsequent data bursts with an interval that is inversely proportional to the minimum guaranteed bandwidth.

6. The method of claim 5, wherein a bandwidth is allocated to the transmission that is greater than said minimum guaranteed bandwidth, and said subsequent data bursts have a burst size such that the transmission bandwidth corresponds substantially to the allocated bandwidth.

7. The method of claim 1, wherein the link comprises a high-latency link.

8. The method of claim 1, wherein the link comprises a wireless link.

9. The method of claim 7 or claim 8, wherein the link comprises a satellite link.

10. The method of claim 1, wherein the start protocol is a TCP start protocol.

11. A method of performing a TCP start protocol in a TCP connection that includes a satellite link for which a minimum guaranteed bandwidth is negotiable, comprising:
a. negotiating a minimum guaranteed bandwidth for the satellite link;
b. sending data packets at a constant rate over the TCP connection such that the inter-packet interval is proportional to the size of the data packets and inversely proportional to the negotiated minimum guaranteed bandwidth, until an acknowledgement is received.

12. Apparatus for performing a data transmission start protocol over a link, comprising:
a. means for determining a minimum guaranteed bandwidth for transmission over the link; and
b. a transmitter arranged to transmit a plurality of data bursts over the link with an interval between bursts determined such that the transmission bandwidth does not significantly exceed the minimum guaranteed bandwidth; wherein the plurality of bursts are transmitted before receiving an acknowledgement of any of said plurality of bursts.

13. The apparatus of claim 12, wherein the interval is inversely proportional to the minimum guaranteed bandwidth.

14. The apparatus of claim 12, wherein each of said data bursts is of substantially equal size, the interval being proportional to said data burst size.

15. The apparatus of claim 12, wherein each of said data bursts comprises a single data packet.

16. The apparatus of claim 12, wherein the transmitter is arranged to transmit, subsequent to reception of said acknowledgement, subsequent data bursts with an interval that is inversely proportional to the minimum guaranteed bandwidth.

17. The apparatus of claim 16, wherein a bandwidth is allocated to the transmission that is greater than said minimum guaranteed bandwidth, and said subsequent data bursts have a burst size such that the transmission bandwidth corresponds substantially to the allocated bandwidth.

18. The apparatus of claim 12, wherein the link comprises a high-latency link.

19. The apparatus of claim 12, wherein the link comprises a wireless link.

20. The apparatus of claim 12, wherein the link comprises a satellite link.

21. The apparatus of claim 12, wherein the start protocol is a TCP start protocol.

22. A computer program product comprising a computer useable medium including program code stored therein, the program code enabling the performance of a data transmission start protocol over a link, comprising: program code means arranged to determine a minimum guaranteed bandwidth for transmission over the link; and to transmit a plurality of data bursts over the link with an interval between bursts determined such that the transmission bandwidth does not significantly exceed the minimum guaranteed bandwidth; wherein the plurality of bursts are transmitted before receiving an acknowledgement of any of said plurality of bursts.

23. The computer program product of claim 22, wherein the interval is inversely proportional to the minimum guaranteed bandwidth.

24. The computer program product of claim 22, wherein each of said data bursts is of substantially equal size, the interval being proportional to said data burst size.

25. The computer program product of claim 22, wherein each of said data bursts comprises a single data packet.

26. The computer program product of claim 22 arranged to transmit, subsequent to reception of said acknowledgement, data bursts with an interval that is inversely proportional to the minimum guaranteed bandwidth.

27. The computer program product of claim 26, wherein a bandwidth is allocated to the transmission that is greater than said minimum guaranteed bandwidth, and said subsequent data bursts have a burst size such that the transmission bandwidth corresponds substantially to the allocated bandwidth.

28. The computer program product of claim 22, wherein the start protocol is a TCP start protocol.
